(19) United States
(12) Patent Application Publication
(10) Pub. No.: US 2011/0072702 A1
(43) Pub. Date: Mar. 31, 2011

(54) Medical alert system

(76) Inventor: Mark Streisfeld, Boca Raton, FL (US)

(21) Appl. No.: 12/927,735

(22) Filed: Nov. 22, 2010

Related U.S. Application Data
(63) Continuation of application No. 11/809,754, filed on Jun. 1, 2007.

(51) Int. Cl. G09F 3/16

(52) U.S. Cl. 40/666

(57) ABSTRACT

A medical alert system provides vital personal medical information in case of an emergency. The system includes a clip that has deformable tabs attachable to an item of personal jewelry and a medallion affixed to a top surface of the clip so that the medallion is raised and prominently positioned relative to the clip. The medallion includes recognized medical alert symbology and directions for locating a source of personal and medical information prominently displayed on a top face. The personal medical information is recorded on a medical information card that can be located in an individual's wallet or pocketbook.

### BACKGROUND OF THE INVENTION

This application is a Continuation Patent Application of co-pending U.S. patent application Ser. No. 11/809,754 filed on Jun. 1, 2007.

### Field of the Invention

The present invention relates to providing emergency medical information, and more particularly, to a system that can be carried by an individual for alerting and providing emergency medical personnel with the individual's important medical information.

### DISCUSSION OF THE RELATED ART

As our society has evolved over the years, we have become increasingly sensitive to everyone's well being such that our communities, whether urban or rural, have a number of first responders throughout the community trained to handle a variety of emergencies. These first responders include law enforcement officers, firefighters, and emergency medical technicians. When a medical emergency occurs, these responders are typically the first on the scene to provide critical first aid, and in serious situations they are trained to employ various life saving techniques. Often, such first aid must be administered to an unconscious individual, or to an individual who is disoriented as a result of injuries or shock. Thus, these individuals are often not able to assist the first responders with even the most basic information about themselves.

In most cases, the lack of information about the individual is of little consequence in the course of emergency treatment; however, some individuals have preexisting conditions that may medically preclude the administration of some procedures, treatments, or drugs. In years past, individuals did not migrate far from their place of birth and friends and relatives were readily accessible for consultation in the cases where the individual was unable to provide information. Today's society has become much more mobile and individuals often live hundreds of miles from their place of birth and now live in a virtual sea of strangers where very few people are knowledgeable about the individual's medical history, and thus there is no one available with whom to consult. Further, in an emergency, the responder providing emergency treatment does not have the luxury of trying to locate someone to consult with and must make critical on-scene life and death decisions. The responder requires immediate knowledge about an individual's pre-existing health conditions that have a bearing on the course of treatment to be followed, including any prescription drugs the individual uses to treat these health conditions.

As a result of this need, various “medical alert” jewelry has been developed for an individual to wear. Such jewelry has taken the form of bracelets, lockets, necklaces, charms, etc. These pieces of jewelry have a universally recognizable medical alert symbol imprinted thereon for alerting a responder that the individual has a preexisting condition that may have a bearing on treatment. While the jewelry has the medical alert symbol, the amount of information provided beyond the alert symbol is often limited.

Some individuals may carry medical information cards on their person in lieu of wearing a piece of medical alert jewelry for various reasons such as work safety, aesthetics, etc. If an individual carries such a card instead of medical alert jewelry, the responder must search the individual's pockets, briefcase, handbag, or wallet searching for the card. In fact, the responder does not even know if such a card exists and can waste valuable time performing such a search, and in some areas conducting such a search can be considered an invasion of the individual's privacy.

Thus, there is a need for a system that can be employed by an individual to provide an outward visual symbol alerting a responder that a preexisting medical condition exists and which includes directions on the symbol to direct the responder to a place where the individual has recorded the necessary emergency information.

### SUMMARY OF THE INVENTION

The present invention is directed to a medical alert system that satisfies the need for an outwardly visible indicator of a preexisting medical condition and also provides sufficient medical information for a responder administering emergency medical treatment. The medical alert system includes an alert clip that has deformable tabs attachable to an item of personal jewelry. The alert clip includes recognized medical alert symbology and directions for locating a source of personal and medical information. The personal medical information is recorded on a medical information card that can be located in an individual's wallet or pocketbook.

Another aspect of the present invention includes a medallion as a part of the alert clip wherein the medallion bears the medical alert symbology. The symbology includes all or in part thereof, a red hexagonal border around a red six-legged cross upon which is superimposed a caduceus and wherein the locating directions include a worded message superimposed over a part of the medical alert symbology.

Yet another aspect of the present invention is a medical information card for storage in a wallet or pocketbook, etc. The card has a writable surface and a plurality of data entry fields thereon for recording personal information such as an individual's identity, place of residence, personal physician, emergency contacts, and existing medical conditions and prescription drugs taken by the individuals so that an emergency care giver can be properly informed when administering emergency treatments.

These and other features, aspects, and advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view of a medical alert system embodying the present invention, wherein an alert clip is affixed to an individual's watch band and an information card is stored in the individual's wallet;

FIG. 2 is a front elevational view of an alert clip;

FIG. 3 is a rear elevational view of the alert clip shown in FIG. 2;

FIG. 4 is a cross-sectional view of a watch band wherein the alert clip shown in FIG. 2 is affixed thereto;

FIG. 5 is an elevational view of the medical information card shown in FIG. 1.

Like reference numerals refer to like parts throughout the several views of the drawings.

### DETAILED DESCRIPTION OF THE PREFERRED EMBODIMENTS

For purposes of description herein, the terms “upper”, “lower”, “left”, “rear”, “right”, “front”, “vertical”, “horizontal”, and derivatives thereof shall relate to the invention as oriented in FIGS. 2 and 5. However, one will understand that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

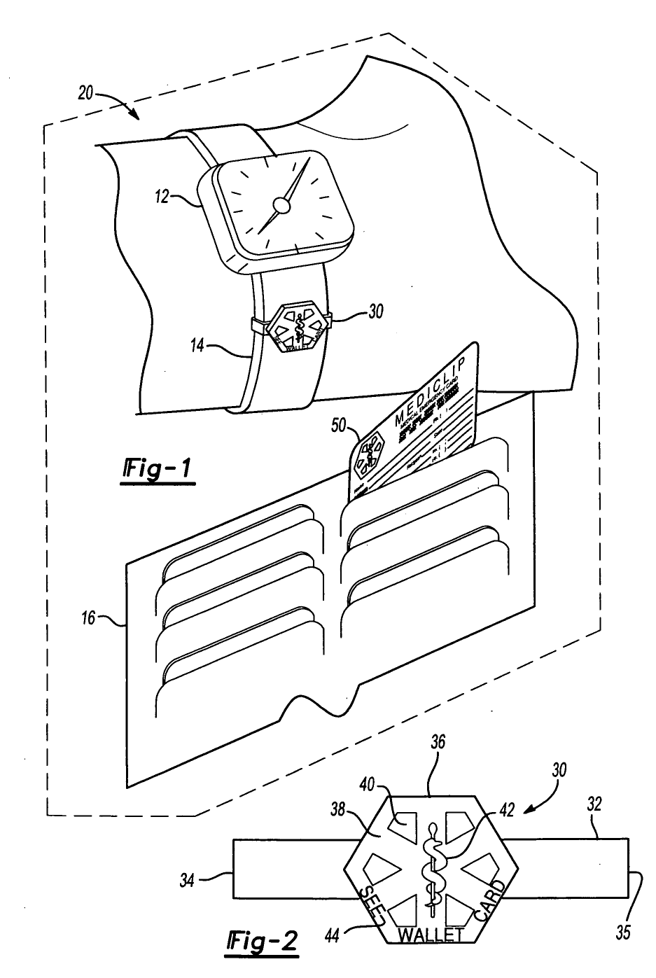

Turning to the drawings, FIG. 1 shows a medical alert system 20 which is one of the preferred embodiments of the present invention and illustrates its various components. An individual wearing a watch 12 secured to a wrist with wristband 14 has an alert clip 30 clasped thereto and further has a medical information card 50 stored in a wallet 16 which is also carried by the individual.

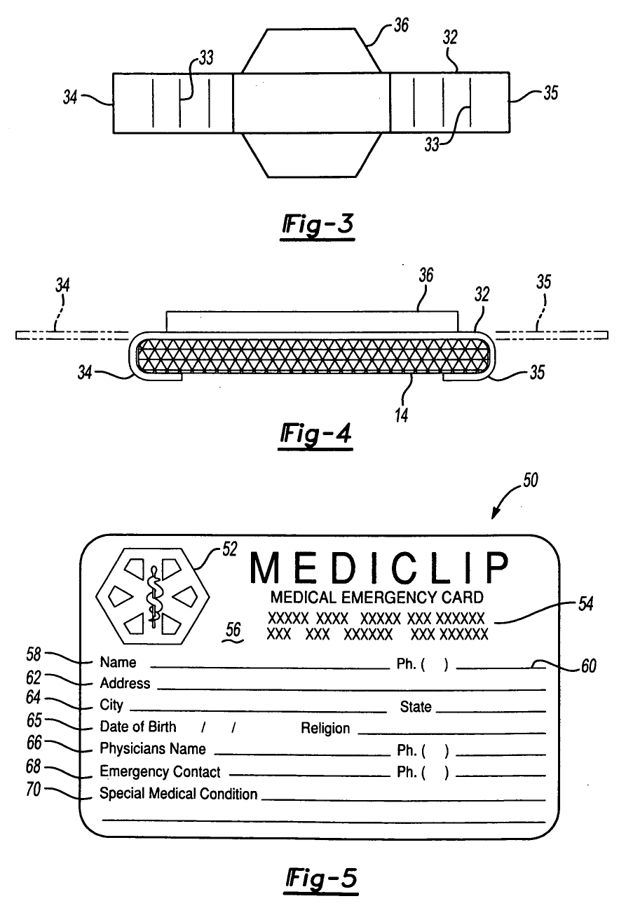

Turning now to FIGS. 2 and 3, alert clip 30 has an elongate clasp bar 32 having a first deformable tab 34 at one end of clasp bar 32 and a second deformable tab 35 at an opposite second end of clasp bar 32. As illustrated in FIG. 3, a rear surface of clasp bar 32 includes and defines therein a plurality of regularly spaced parallel scorings 33. Scorings 33 are oriented substantially perpendicular to an elongate axis of clasp bar 32 and parallel to a bend axis of deformable tabs 34, 35. Clasp bar 32 is formed of an easily but permanently deformable material such as a soft metal and further includes an outer coating or plating such as a simulated precious metal to provide an aesthetically pleasing appearance. The coating or plating is one that will not discolor and detract from the aesthetics of alert clip 30.

A medallion 36 is affixed to and substantially centered on the front surface of clasp bar 32 so that the medallion 36 is raised above the front surface of the clasp bar 32 and prominently displayed for attracting attention. Medallion 36 further has embossed thereon recognizable and approved medical alert symbology. As illustrated, this symbology includes a red colored six-legged cross 38 which is often associated with medical alert symbology and is imposed over a white background 40 for improved recognition. A caduceus 42 is superimposed over the six-legged cross 38. The caduceus 42 has long been associated with the medical field, and it's visible presence on a piece of jewelry worn by an individual or as an accessory thereto is an approved symbol indicating that medical alert information for the wearer is associated therewith. Emergency medical personnel are trained to look for jewelry, bracelets, etc. bearing this symbology when responding to a medical emergency and the raised and prominent display of the medallion 36 makes it easy for emergency repsonders to see the medical alert symbology within a few seconds of first examination of the patient.

To further improve the visibility and recognizability of the medical alert symbology, the medallion 36 can be formed as a hexagon (also associated with medical alerts) and the symbology thereon can, as illustrated, be framed in a hexagon and colored red. Directions for locating information card 50 such as word message 44 is embossed on medallion 36 and positioned in proximity to caduceus 42. Word message 44 as illustrated is positioned below caduceus 42 within the red hexagonal border of medallion 36 and says “SEE WALLET CARD” and is preferably superimposed over a portion of the medical alert symbology. Such a word message 44 thus directs the emergency medical personnel to the specific location where medical information card 50 can be found and provides implied consent for the emergency medical personnel to search the individual for information card 50.

In use, and now referring to FIG. 4, an individual places alert clip 30 upon an outer surface of watch band 14 (or other item regularly worn by the individual such as a bracelet, etc.). First deformable tab 34 is then bent downwardly and around the outer edge of watchband 14. Second deformable tab 35 is similarly bent downwardly and around the opposite outer edge of watch band 14. The bending of deformable tabs 34, 35 is facilitated by scorings 33 on the rear surface of clasp bar 32. Once bent in such manner, additional pressure on tabs 34, 35 against the bottom surface of watchband 14 will further secure alert clip in position on watchband 14.

As shown in FIG. 5, medical information card 50 is formed from a solid resinous sheet similar to the materials used for credit cards or other cards subject to being carried for prolonged periods in an individual's wallet or handbag. Card 50 is similarly sized to a credit card, driver's license, or other like cards. Information card 50 has embossed thereon, and preferably located at an upper portion thereof, medical alert indicia 52 that is substantially a visual reproduction of the medical alert symbology contained on medallion 36. The indicia 52 of the reproduced medical alert symbology will assist the emergency personnel to associate card 50 with alert clip 30 and thereby identify card 50 as containing needed medical information. Card 50 can also contain at a top portion thereof printed information 54 indicating that the card 50 contains emergency medical information and further identifying the distributor of the card.

A lower portion of medical information card 50 has a plurality of data fields identified thereon for the individual to fill in with personal and medical information. For this purpose, surface 56 of card 50 is treated such that surface 56 will readily accept and retain thereon the ink of a pen or marker used to fill in the various data fields. A name field 58 is for the name of the individual and phone number field 60 is for the phone number of the individual. An address field 62 and city and state fields 64 identify the location of the individual's residence. Miscellaneous fields 65 can include such information as date of birth, religion, blood type, etc. that may be of further import to the emergency medical personnel. Physician fields 66 provide name and contact information for the individual's personal physician. Emergency contact fields 68 provide identification and contact information for a close relative or friend of the individual who is to be contacted in case of emergency. Finally, medical condition field 70 provides space for the entry of one or more medical conditions of the individual that require consideration during the administration of initial emergency and subsequent medical treatment. This field is sufficiently large to contain multiple conditions if needed and is easily modified or added to as the health of the individual changes over the years.

In use, the individual places medical information card 50 in a wallet 16 or pocket book in a prominent position that is readily visible when wallet 16 is searched. One such preferred position is one of the slots typically formed in wallet 16 formed to accept a standard sized credit card, driver's license, etc. In an emergency wherein the individual is unable to provide the emergency personnel with vital medical information, the emergency personnel will, as a result of their training, look for a medical alert symbol and recognize alert clip 30 as such. Word message 44 on medallion 36 directs the emergency personnel to look in wallet 16 for medical information card 50 containing the medical information necessary for consideration during treatment of the individual whereupon card 50 can be retrieved and used during treatment of the individual.

The above description is considered that of the preferred embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the doctrine of equivalents.

What is claimed is:

1. A medical alert system for providing vital medical information in case of an emergency, said system comprising:
a medical information card for recording vital personal and medical information thereon;
an alert clip attachable to an item of personal jewelry, and including a clasp bar with an elongate axis, and said clasp bar having top and bottom surfaces and first and second deformable tabs at opposite ends thereof, and said first and second deformable tabs including a plurality of scorings on at least one of said top and bottom surfaces, said scorings oriented at substantially right angles to the elongate axis of said clasp bar, and said scorings being structured and disposed to permit bending of said first and second deformable tabs downwardly, inwardly and around the item of personal jewelry with said first and second deformable tabs held against a bottom side of the item of personal jewelry to facilitate attachment of said alert clip thereto; and
said alert clip further including a medallion affixed to said top surface of said clasp bar between said first and second deformable tabs so that said medallion is raised above said top surface and prominently positioned relative to said clasp bar, and said medallion having a main top face surrounded by six side edges and said main top face having medical alert symbology and directions for locating said medical information card prominently displayed thereon.

2. The medical alert system according to claim 1 wherein said medical information card includes a writable surface thereon.

3. The medical alert system according to claim 2 wherein said information card includes a plurality of data fields on said writable surface for recording of an individual's emergency data.

4. A method for alerting emergency responders to vital medical information of a person in case of an emergency, said method comprising the steps of:
providing a medical information card to the person for recording personal information and the vital medical information of the person thereon;
instructing the person to carry the medical information card containing the recorded personal information and vital medical information in the person's wallet;
providing an alert clip along with the medical information card, and the alert clip being attachable to an item of personal jewelry worn by the person, and the alert clip including a clasp bar with an elongate axis, and the clasp bar having top and bottom surfaces and first and second deformable tabs at opposite ends thereof, and the alert clip further including a medallion affixed to the top surface of the clasp bar between the first and second deformable tabs so that the medallion is raised above the top surface of the clasp bar and prominently positioned relative to the clasp bar;
providing medical alert symbology and medical information directions on a top face of the medallion, and the medical information directions including instructions to the emergency responders for locating the medical information card in the person's wallet; and
instructing the person to attach the alert clip to an item of personal jewelry worn by the person by bending the first and second deformable tabs downwardly, inwardly and around the item of personal jewelry with the first and second deformable tabs held against a bottom side of the item of personal jewelry and the top face of the medallion prominently displayed in plain view when the item of personal jewelry is worn on the person.
